(19) United States
(12) Patent Application Publication
(10) Pub. No.: US 2018/0287980 A1
(43) Pub. Date: Oct. 4, 2018

(54) Systems and Methods for Blocking Content Redistribution

(71) Applicant: Facebook, Inc., Menlo Park, CA (US)

(72) Inventors: Dan Barak, Redwood City, CA (US); Christopher Michael Day, Kirkland, WA (US); Gregory Karl Nelson, Seattle, WA (US); Dean Jackson, Seattle, WA (US); John Stephen Ketchpaw, Seattle, WA (US); Ju Yong Yoon, Seattle, WA (US); James F. Geist, JR., Issaquah, WA (US)

(21) Appl. No.: 15/472,152

(22) Filed: Mar. 28, 2017

(51) Int. Cl. H04L 12/58

(52) U.S. Cl. CPC H04L 51/14; H04L 51/12; H04L 51/32

(57) ABSTRACT

In one embodiment, systems and methods for preventing messages from being redistributed are provided. A social-networking system may receive instructions from a user to create a messaging campaign. The instructions may include a blocking instruction. The system may identify a target user of the social-networking system to whom to present a message associated with the messaging campaign and present the message to the target user. The system may receive from the target user an input associated with the presented message. The input may be configured to cause the message to be presented to one or more other users connected to the target user within a threshold degree of separation in a social graph. In response to the input from the target user, the system may determine that the message is associated with the blocking instruction and prevent the message from being presented to the one or more other users.

### TECHNICAL FIELD

This disclosure generally relates to systems and methods for managing information distribution.

### BACKGROUND

Certain information distribution platforms, including social-networking systems, often encourage users to redistribute information. For example, messages posted on a social-networking system may have a variety of interface elements that would cause the messages to be distributed to other users. For instance, a user may directly share a message with one or more friends by, e.g., sending the message to specified friend(s), re-posting the message on the user's or a friend's message board (e.g., a timeline or wall where a user may post content), etc. A user may also indirectly cause a message to be shared, such as by commenting on the message, thereby causing the commenting event along with the message to be posted in another user's newsfeed in the social-networking system.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a Global Positioning System (GPS) receiver, compass, gyroscope, or accelerometer. Such a device may also include functionality for wireless communication, such as BLUETOOTH communication, near-field communication (NFC), or infrared (IR) communication or communication with wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments disclosed herein relates to mechanisms that allow content publishers to prevent certain messages (e.g., notifications, news, advertisements, offers, or any other type of content) from being redistributed on social media. Publishers, for various reasons, may want to control and limit exposure of their messages to only an intended target audience. Publishing messages through a distribution platform (e.g., a social-networking system), however, may subject the messages to the platform's direct and indirect sharing mechanisms. Particular embodiments disclosed herein relates to manners in which the content redistribution may be blocked.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example method for preventing a message from being redistributed.

FIG. 2 illustrates an example network environment associated with a social-networking system.

FIG. 3 illustrates an example social graph.

FIG. 4 illustrates an example computer system.

### DESCRIPTION OF EXAMPLE EMBODIMENTS

Particular embodiments disclosed herein relates to mechanisms that allow content publishers to prevent certain messages (e.g., articles, news, notifications, advertisements, offers, or any other type of content) from being redistributed on social media. Publishers, for various reasons, may want to control and limit exposure of their messages to only an intended target audience. Publishing messages through a distribution platform (e.g., a social-networking system), however, may subject the messages to the platform's direct and indirect sharing mechanisms. Particular embodiments disclosed herein relates to manners in which the content redistribution may be blocked.

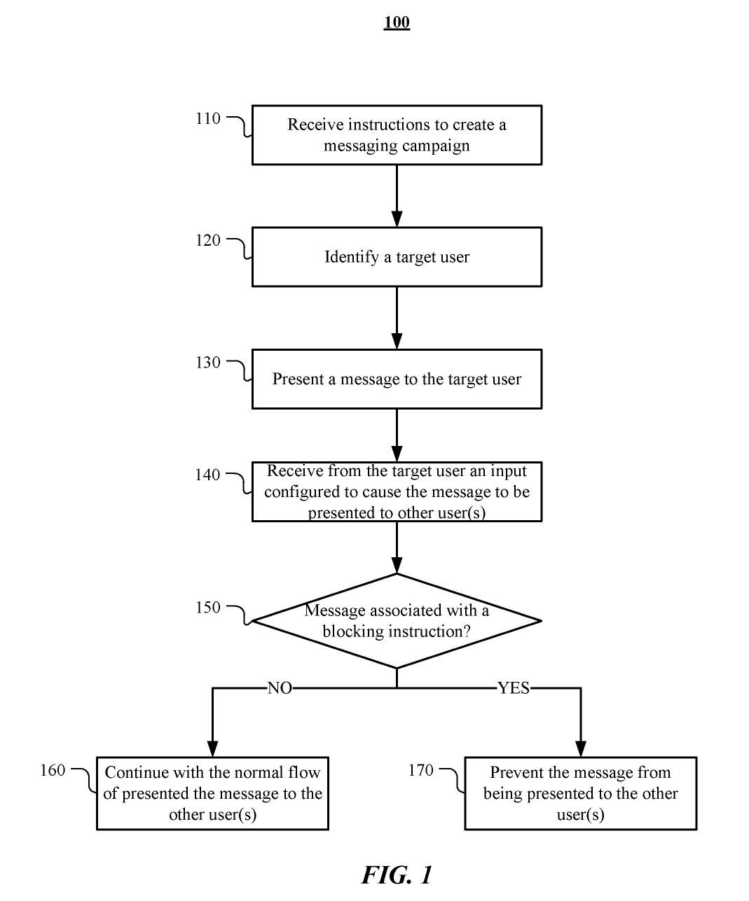

FIG. 1 illustrates an example method 100 for preventing a message to be redistributed. The method may begin at step 110, where a computing device (e.g., a server or distributed computing system) of a content distribution platform, such as a social-networking system, may receive instructions from a user to create a messaging campaign. As an example, the user in this case may be a publishing user wishing to distribute one or more messages through a social-networking system. In particular embodiments, a messaging campaign may comprise a set of rules for distributing messages, including, for example, one or more messages to be distributed, a list of target recipients or criteria for identifying recipients (e.g., age, gender, demographic, interest, purchase history, responsiveness to advertisements, etc.), a time frame for the campaign, messaging frequency, and/or any other rules relating to how the publishing user wishes the messages to be distributed. In particular embodiments, the publishing user may specify the campaign rules via a user interface (e.g., an HTML form interface, such as checkboxes, dropdown lists, input fields, etc.) provided by the distribution platform. In particular embodiments, the publishing user's input through the interface may be transmitted (e.g., via HTTP, SSL, or any other suitable communication protocol) to a server associated with the distribution platform as instructions for creating a messaging campaign. In particular embodiments, the instructions may include a blocking instruction to indicate that the publishing user does not wish messages associated with the messaging campaign to be redistributed. In particular embodiments, upon detecting such a blocking instruction, the distribution platform may persist the instruction (e.g., store it in a database) and associate it with the messaging campaign.

At step 120, the distribution platform may identify a target user in its system (e.g., a user of the social-networking system) to whom to present a message associated with the messaging campaign. In particular embodiments, the target user may be identified based on the list of target recipients specified by the publishing user, or by matching known data about users with the criteria for identifying target recipients. For example, the distribution platform may store profile information of its users and track the users' behavior (e.g., content viewing preferences and patterns, propensity to click on advertisements, purchasing patterns, interests, and any other information gathered from the users) and use such data to identify target users. In particular embodiments, the criteria for identifying the target recipients may be defined by rules (e.g., older than a certain age, of a particular gender, lives in a particular region, have a certain threshold propensity to click on advertisements, etc.). In particular embodiments, the criteria may be defined based on a desired characteristic, such as interest in the subject matter of the messages of the messaging campaign. For example, if the messaging campaign relates to outdoor activities, the criteria may specify that messages are to be sent to users who are interested in outdoor activities. Based on the specified characteristic(s), the distribution platform may use computer models trained using machine learning algorithms to predict which users likely exhibit the desired characteristic(s). Through machine learning, user features that are predictive of the likelihood of a user exhibiting the desired characteristic(s) may be discovered. For example, through machine learning, it may be determined that users who are male, over 50 years old, and like BBQ likely enjoy outdoor activities. In this manner, the publishing user does not have to know the specific predictive features and could simply specify the desired characteristics of target users.

At step 130, the distribution platform may present a message associated with the messaging campaign to the target user. In particular embodiments, the distribution platform may send the message using HTTP or any other suitable communication protocol to a device of the target user and cause the message to be presented on the device. In the context of a social-networking system, the message may be presented as, e.g., a newsfeed item, a timeline item, an advertisement, etc. In particular embodiments, the message may be presented along with user interface controls that allow actions to be performed with respect to the message. For example, the message may be presented with a “share” interface, the activation of which may cause the associated message to be shared with other users. For instance, the target user may use the share interface to share the message with particular users that he/she identifies (e.g., the message may be sent privately or posted on the identified users' timelines). As another example, the share interface may be used to post the message on the timeline of the target user or a specified user. Other users viewing the timeline may then see the message. In particular embodiments, messages may also be shared indirectly when the target user comments on the message or specifies an affinity towards it (e.g., rating it or specifying whether he/she “likes” the message). A comment or an affinity input by the target user may trigger the creation of edge stories for friends of the target user, which in effect would cause the message to be shared. For example, other users connected to the target user in a social graph of the social-networking system may see a notification indicating that the target user made a comment (e.g., “Bob commented on <the message>”) or specified an affinity towards the message (e.g., “Bob liked <the message>”). The message may be shown in the notification itself or a link may be provided to allow others to see the message. In particular embodiments, an URI (Uniform Resource Identifier) associated with the message may be copied by the target user and sent to any other person (e.g., via email, a messaging system, etc.). That person may enter at least a portion of the URI (e.g., the URL) into a web browser, for example, and access the message.

At step 140, the distribution platform may receive from the target user an input associated with the presented message. The input may be configured to cause the message to be presented to one or more other users (e.g., a share action or a comment, as described above). In particular embodiments, those other users may be connected to the target user within a threshold degree of separation in a social graph of a social-networking system. For example, users who are directly connected to the target user (i.e., within 1 degree of separation from the target user) and users who are directly connected to someone who is directly connected to the target user (i.e., within 2 degrees of separation from the target user) may be configured to see the message.

At step 150, the distribution platform may, in response to the input from the target user, determine whether the message associated with the input is associated with a blocking instruction. In particular embodiments, the input from the target user may include information identifying the message with which the input is associated. In particular embodiments, the information identifying the message may be used to look up whether it is associated with a messaging campaign that has a blocking instruction.

In particular embodiments, if the message is not subject to a blocking instruction 160, the normal processing flow may proceed. For example, the message may be shared with others in a manner specified by the target user (e.g., through direct messaging, timeline posting, etc.).

On the other hand, if the message is associated with a blocking instruction 170, the distribution platform may prevent the message from being presented to the other users to whom the message may otherwise be presented. In particular embodiments, in response to an input indicating a share command, the distribution platform may present a message indicating that the message cannot be shared and prevent the normal processing flow for sharing messages from executing. This may be implemented on the server side or the client side. For example, with server-side implementations, a share request may be received by the server and, upon determining that the associated message is subject to a block instruction, the server may send an error message to the client device for display and terminate further processing of the share command. With client-side implementation, for example, client-side code (e.g., HTML, JavaScript) may be dynamically generated and configured by server-side code (e.g., PHP, JSP) to handle share commands appropriately. For instance, for messages where sharing is disabled, the corresponding client-side code generated by the server may be configured to display an error message upon detection of a share command from the user and not send a corresponding share command back to the server. In particular embodiments, the user interface for sharing may be disabled (e.g., grayed out or not shown). For example, server-side scripting code (e.g., PHP, JSP) may check whether the “share” feature should be disabled and remove the feature from the user interface accordingly (e.g., the share feature may be disabled in the resulting HTML/JavaScript code). As another example, client-side scripting code (e.g., HTML/JavaScript) may be used to disable the “share” feature at rendering time.

In particular embodiments where the input from the target user is a comment or affinity indicator, the distribution platform may prevent edge stories from being created or a notification from being sent regarding the target user's input. This may be implemented on the server side or the client side. With server-side implementations, for example, the server, upon receiving an incoming comment/affinity from the target user, may check whether the associated message is subject to a block instruction and decide accordingly whether to trigger the edge-story or notification creation flow. With client-side implementation, for example, the user interface (e.g., HTML, JavaScript) associated with the message may be generated (e.g., by server-side PHP or JSP code) such that user comments would not trigger the edge story or notification flow. For instance, the client-side code associated with a comment/affinity interface may be configured such that it may inform the server that the edge story or notification flow should not be triggered, or alternatively it may submit the comment/affinity data to a different server handler that does not create edge stories or generate notifications. As a result, despite the target user entering a comments and/or affinity indication (which the publishing user may desire), the message would not be presented to other users (e.g., via the timeline or newsfeed of the target user or his/her friends and followers).

In particular embodiments, the distribution platform may further restrict direct URI access to messages subject to blocking instructions. In particular embodiments, a URI may be associated with a message that is subject to a blocking instruction. This URI may be copied-and-pasted by the target user and shared with another user (a non-target user), who may then enter the URI into a web browser in an attempt to retrieve the message. In particular embodiments, the distribution platform may receive at least a portion of the URI (e.g., a URL) from the non-target user. Upon receiving the request for the message, the distribution platform in particular embodiments may check whether the message is subject to sharing restrictions (e.g., whether it is associated with a blocking instruction) and determine whether the requesting user is an intended target recipient of the message. In particular embodiments, the distribution platform may require the requesting user to log in, and such login information may be used to determine whether the requesting user is one of the intended target recipients or users intended to see messages associated with the messaging campaign. If the requesting user is not an intended target recipient, then the distribution platform may deny access to the message and present an error message (e.g., “Sorry this content cannot be shared.”).

To prevent this blocking mechanism from being used to discover the nature of the targeted recipients (e.g., by having various users try the URI and identifying profile patterns of those who are able to access the message), certain measures may be implemented to ensure such information is not discovered. For example, the URI of each message may be user-specific, which means no other user may view it even if that user is also part of the intended target recipients. In particular embodiments, the URI associated with the message may comprise information that uniquely identifies the target user for that message. If a non-target user obtains the URI and attempts to request the associated message, the distribution platform may determine whether the requesting user (e.g., based on his/her login information) matches the information in the user-specific URI that uniquely identifies the target user. If no match is found, the distribution platform may deny access to the message. On the other hand, if the requesting user is the target user, then access to the message may be granted, resulting in the message being presented to the requesting user.

Particular embodiments may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates an example method for preventing a message from being redistributed including the particular steps of the method of FIG. 1, this disclosure contemplates any suitable method for preventing a message from being redistributed, including any suitable steps, which may include all, some, or none of the steps of the method of FIG. 1, where appropriate. Furthermore, although this disclosure describes and illustrates particular components, devices, or systems carrying out particular steps of the method of FIG. 1, this disclosure contemplates any suitable combination of any suitable components, devices, or systems carrying out any suitable steps of the method of FIG. 1.

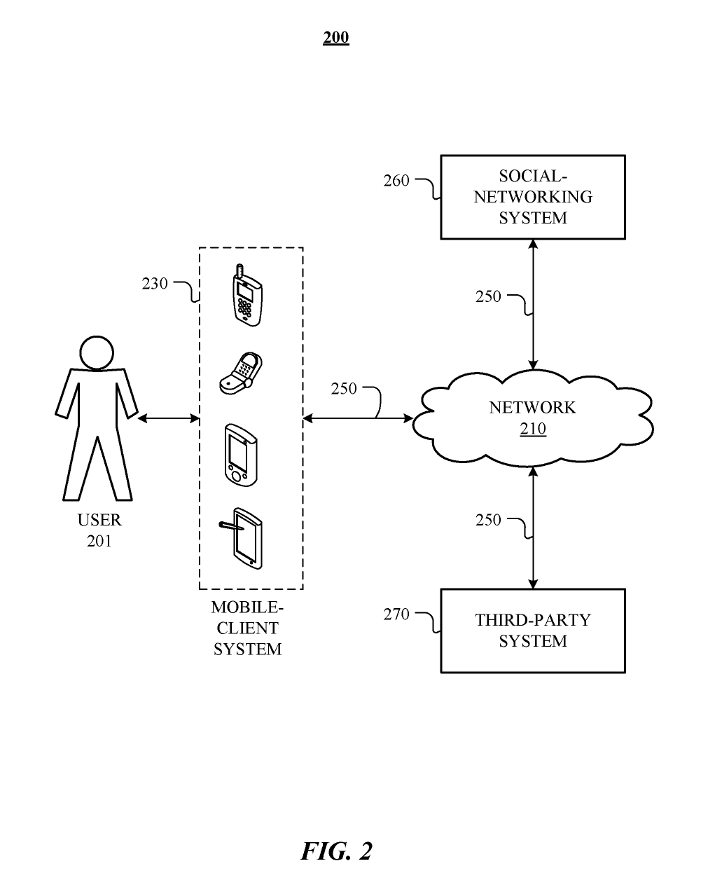

FIG. 2 illustrates an example network environment 200 associated with a social-networking system. Network environment 200 includes a user 201, a client system 230, a social-networking system 260, and a third-party system 270 connected to each other by a network 210. Although FIG. 2 illustrates a particular arrangement of user 201, client system 230, social-networking system 260, third-party system 270, and network 210, this disclosure contemplates any suitable arrangement of user 201, client system 230, social-networking system 260, third-party system 270, and network 210. As an example and not by way of limitation, two or more of client system 230, social-networking system 260, and third-party system 270 may be connected to each other directly, bypassing network 210. As another example, two or more of client system 230, social-networking system 260, and third-party system 270 may be physically or logically co-located with each other in whole or in part. Moreover, although FIG. 2 illustrates a particular number of users 201, client systems 230, social-networking systems 260, third-party systems 270, and networks 210, this disclosure contemplates any suitable number of users 201, client systems 230, social-networking systems 260, third-party systems 270, and networks 210. As an example and not by way of limitation, network environment 200 may include multiple users 201, client system 230, social-networking systems 260, third-party systems 270, and networks 210.

In particular embodiments, user 201 may be an individual (human user), an entity (e.g., an enterprise, business, or third-party application), or a group (e.g., of individuals or entities) that interacts or communicates with or over social-networking system 260. In particular embodiments, social-networking system 260 may be a network-addressable computing system hosting an online social network. Social-networking system 260 may generate, store, receive, and send social-networking data, such as, for example, user-profile data, concept-profile data, social-graph information, or other suitable data related to the online social network. Social-networking system 260 may be accessed by the other components of network environment 200 either directly or via network 210. In particular embodiments, social-networking system 260 may include an authorization server (or other suitable component(s)) that allows users 201 to opt in to or opt out of having their actions logged by social-networking system 260 or shared with other systems (e.g., third-party systems 270), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. In particular embodiments, third-party system 270 may be a network-addressable computing system that can host definitions for a messaging campaign, including the messages themselves. Third-party system 270 may generate, store, receive, and send messages. Third-party system 270 may be accessed by the other components of network environment 200 either directly or via network 210. In particular embodiments, one or more users 201 may use one or more client systems 230 to access, send data to, and receive data from social-networking system 260 or third-party system 270. Client system 230 may access social-networking system 260 or third-party system 270 directly, via network 210, or via a third-party system. As an example and not by way of limitation, client system 230 may access third-party system 270 via social-networking system 260. Client system 230 may be any suitable computing device, such as, for example, a personal computer, a laptop computer, a cellular telephone, a smartphone, a tablet computer, or an augmented/virtual reality device.

This disclosure contemplates any suitable network 210. As an example and not by way of limitation, one or more portions of network 210 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 210 may include one or more networks 210.

Links 250 may connect client system 230, social-networking system 260, and third-party system 270 to communication network 210 or to each other. This disclosure contemplates any suitable links 250. In particular embodiments, one or more links 250 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 250 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 250, or a combination of two or more such links 250. Links 250 need not necessarily be the same throughout network environment 200. One or more first links 250 may differ in one or more respects from one or more second links 250.

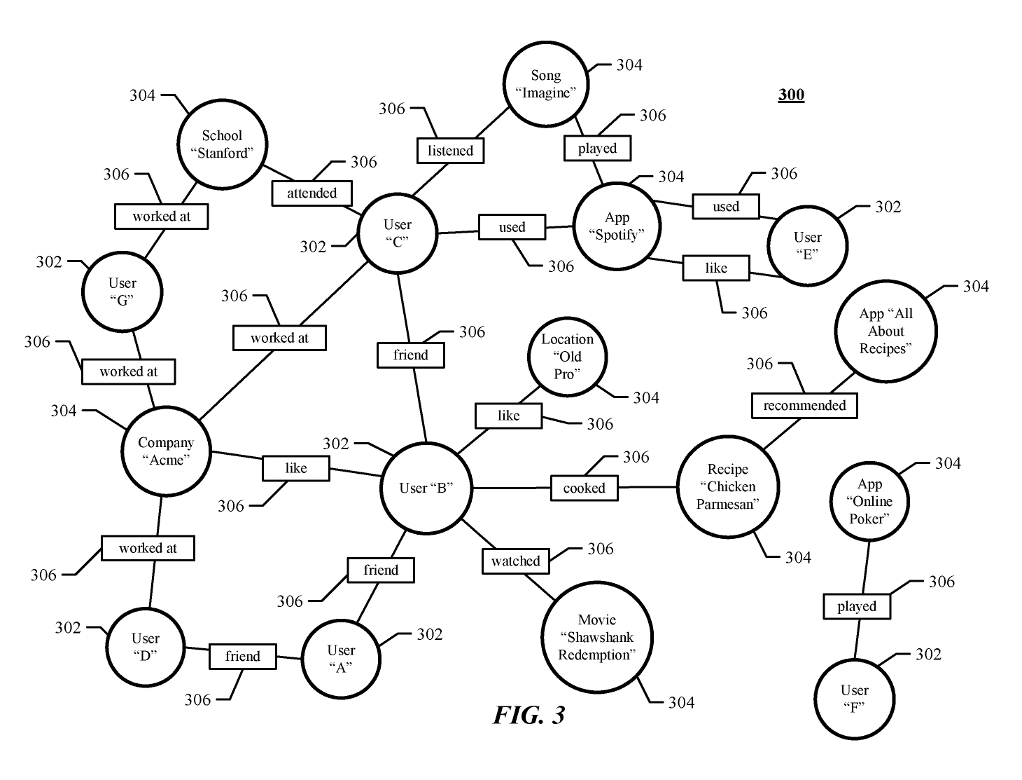

FIG. 3 illustrates example social graph 300. In particular embodiments, social-networking system 260 may store one or more social graphs 300 in one or more data stores. In particular embodiments, social graph 300 may include multiple nodes—which may include multiple user nodes 302 or multiple concept nodes 304—and multiple edges 306 connecting the nodes. Example social graph 300 illustrated in FIG. 3 is shown, for didactic purposes, in a two-dimensional visual map representation. In particular embodiments, a social-networking system 260, client system 230, or third-party system 270 may access social graph 300 and related social-graph information for suitable applications. The nodes and edges of social graph 300 may be stored as data objects, for example, in a data store (such as a social-graph database). Such a data store may include one or more searchable or queryable indexes of nodes or edges of social graph 300.

In particular embodiments, a user node 302 may correspond to a user of social-networking system 260. As an example and not by way of limitation, a user may be an individual (human user), an entity (e.g., an enterprise, business, or third-party application), or a group (e.g., of individuals or entities) that interacts or communicates with or over social-networking system 260. In particular embodiments, when a user registers for an account with social-networking system 260, social-networking system 260 may create a user node 302 corresponding to the user, and store the user node 302 in one or more data stores. Users and user nodes 302 described herein may, where appropriate, refer to registered users and user nodes 302 associated with registered users. In addition or as an alternative, users and user nodes 302 described herein may, where appropriate, refer to users that have not registered with social-networking system 260. In particular embodiments, a user node 302 may be associated with information provided by a user or information gathered by various systems, including social-networking system 260. As an example and not by way of limitation, a user may provide his or her name, profile picture, contact information, birth date, sex, marital status, family status, employment, education background, preferences, interests, or other demographic information. In particular embodiments, a user node 302 may be associated with one or more data objects corresponding to information associated with a user. In particular embodiments, a user node 302 may correspond to one or more webpages.

In particular embodiments, a concept node 304 may correspond to a concept. As an example and not by way of limitation, a concept may correspond to a place (such as, for example, a movie theater, restaurant, landmark, or city); a website (such as, for example, a website associated with social-network system 260 or a third-party website associated with a web-application server); an entity (such as, for example, a person, business, group, sports team, or celebrity); a resource (such as, for example, an audio file, video file, digital photo, text file, structured document, or application) which may be located within social-networking system 260 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 304 may be associated with information of a concept provided by a user or information gathered by various systems, including social-networking system 260. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 304 may be associated with one or more data objects corresponding to information associated with concept node 304. In particular embodiments, a concept node 304 may correspond to one or more webpages.

In particular embodiments, a node in social graph 300 may represent or be represented by a webpage (which may be referred to as a “profile page”). Profile pages may be hosted by or accessible to social-networking system 260. Profile pages may also be hosted on third-party websites associated with a third-party system 270. As an example and not by way of limitation, a profile page corresponding to a particular external webpage may be the particular external webpage and the profile page may correspond to a particular concept node 304. Profile pages may be viewable by all or a selected subset of other users. As an example and not by way of limitation, a user node 302 may have a corresponding user-profile page in which the corresponding user may add content, make declarations, or otherwise express himself or herself. As another example and not by way of limitation, a concept node 304 may have a corresponding concept-profile page in which one or more users may add content, make declarations, or express themselves, particularly in relation to the concept corresponding to concept node 304.

In particular embodiments, a concept node 304 may represent a third-party webpage or resource hosted by a third-party system 270. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 230 to send to social-networking system 260 a message indicating the user's action. In response to the message, social-networking system 260 may create an edge (e.g., a check-in-type edge) between a user node 302 corresponding to the user and a concept node 304 corresponding to the third-party webpage or resource and store edge 306 in one or more data stores.

In particular embodiments, a pair of nodes in social graph 300 may be connected to each other by one or more edges 306. An edge 306 connecting a pair of nodes may represent a relationship between the pair of nodes. In particular embodiments, an edge 306 may include or represent one or more data objects or attributes corresponding to the relationship between a pair of nodes. As an example and not by way of limitation, a first user may indicate that a second user is a “friend” of the first user. In response to this indication, social-networking system 260 may send a “friend request” to the second user. If the second user confirms the “friend request,” social-networking system 260 may create an edge 306 connecting the first user's user node 302 to the second user's user node 302 in social graph 300 and store edge 306 as social-graph information in one or more of data stores 264. In the example of FIG. 3, social graph 300 includes an edge 306 indicating a friend relation between user nodes 302 of user “A” and user “B” and an edge indicating a friend relation between user nodes 302 of user “C” and user “B.” Although this disclosure describes or illustrates particular edges 306 with particular attributes connecting particular user nodes 302, this disclosure contemplates any suitable edges 306 with any suitable attributes connecting user nodes 302. As an example and not by way of limitation, an edge 306 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 300 by one or more edges 306.

In particular embodiments, an edge 306 between a user node 302 and a concept node 304 may represent a particular action or activity performed by a user associated with user node 302 toward a concept associated with a concept node 304. As an example and not by way of limitation, as illustrated in FIG. 3, a user may “like,” “attended,” “played,” “listened,” “cooked,” “worked at,” or “watched” a concept, each of which may correspond to an edge type or subtype. A concept-profile page corresponding to a concept node 304 may include, for example, a selectable “check in” icon (such as, for example, a clickable “check in” icon) or a selectable “add to favorites” icon. Similarly, after a user clicks these icons, social-networking system 260 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 260 may create a “listened” edge 306 and a “used” edge (as illustrated in FIG. 3) between user nodes 302 corresponding to the user and concept nodes 304 corresponding to the song and application to indicate that the user listened to the song and used the application. Moreover, social-networking system 260 may create a “played” edge 306 (as illustrated in FIG. 3) between concept nodes 304 corresponding to the song and the application to indicate that the particular song was played by the particular application. In this case, “played” edge 306 corresponds to an action performed by an external application (SPOTIFY) on an external audio file (the song “Imagine”). Although this disclosure describes particular edges 306 with particular attributes connecting user nodes 302 and concept nodes 304, this disclosure contemplates any suitable edges 306 with any suitable attributes connecting user nodes 302 and concept nodes 304. Moreover, although this disclosure describes edges between a user node 302 and a concept node 304 representing a single relationship, this disclosure contemplates edges between a user node 302 and a concept node 304 representing one or more relationships. As an example and not by way of limitation, an edge 306 may represent both that a user likes and has used at a particular concept. Alternatively, another edge 306 may represent each type of relationship (or multiples of a single relationship) between a user node 302 and a concept node 304 (as illustrated in FIG. 3 between user node 302 for user “E” and concept node 304 for “SPOTIFY”).

In particular embodiments, social-networking system 260 may create an edge 306 between a user node 302 and a concept node 304 in social graph 300. As an example and not by way of limitation, a user viewing a concept-profile page (such as, for example, by using a web browser or a special-purpose application hosted by the user's client system 230) may indicate that he or she likes the concept represented by the concept node 304 by clicking or selecting a “Like” icon, which may cause the user's client system 230 to send to social-networking system 260 a message indicating the user's liking of the concept associated with the concept-profile page. In response to the message, social-networking system 260 may create an edge 306 between user node 302 associated with the user and concept node 304, as illustrated by “like” edge 306 between the user and concept node 304. In particular embodiments, social-networking system 260 may store an edge 306 in one or more data stores. In particular embodiments, an edge 306 may be automatically formed by social-networking system 260 in response to a particular user action. As an example and not by way of limitation, if a first user uploads a picture, watches a movie, or listens to a song, an edge 306 may be formed between user node 302 corresponding to the first user and concept nodes 304 corresponding to those concepts. Although this disclosure describes forming particular edges 306 in particular manners, this disclosure contemplates forming any suitable edges 306 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more web pages, in one or more e-mails, or in connection with search results requested by a user. In addition or as an alternative, an advertisement may be one or more sponsored stories (e.g., a news-feed or ticker item on social-networking system 260). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system 260. In addition or as an alternative, the social action may be promoted outside or off of social-networking system 260, where appropriate. In particular embodiments, a page may be an on-line presence (such as a webpage or website within or outside of social-networking system 260) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 260. Sponsored stories are more likely to be viewed by users, at least in part because sponsored stories generally involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. Patent Application Publication No. 2012/0203831, entitled “Sponsored Stories Unit Creation from Organic Activity Stream” and filed 3 Feb. 2012 as U.S. patent application Ser. No. 13/020,745, or U.S. Patent Application Publication No. 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation.

As described above, an advertisement may be text (which may be HTML-linked), one or more images (which may be HTML-linked), one or more videos, audio, one or more ADOBE FLASH files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. An advertisement may be displayed within dedicated pages, requiring the user to interact with or watch the advertisement before the user may access a page, utilize an application, or play a game. The user may, for example view the advertisement through a web browser.

A user may interact with an advertisement in any suitable manner. The user may click or otherwise select the advertisement, and the advertisement may direct the user (or a browser or other application being used by the user) to a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 260) or RSVP (e.g., through social-networking system 260) to an event associated with the advertisement. In addition or as an alternative, an advertisement may include social-networking-system content directed to the user. For example, an advertisement may display information about a friend of the user within social-networking system 260 who has taken an action associated with the subject matter of the advertisement.

Social-networking-system functionality or content may be associated with an advertisement in any suitable manner. For example, an advertising system (which may include hardware, software, or both for receiving bids for advertisements and selecting advertisements in response) may retrieve social-networking functionality or content from social-networking system 260 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed 5 Oct. 2010 as U.S. patent application Ser. No. 12/898,662, and in U.S. Patent Application Publication No. 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 260.

Particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 260 to identify those users. In addition or as an alternative, social-networking system 260 may use user-profile information in social-networking system 260 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 260, off or outside of social-networking system 260, or on mobile computing devices of users. When on or within social-networking system 260, such targeting may be directed to users' news feeds, search results, e-mail or other in-boxes, or notifications channels or may appear in particular area of web pages of social-networking system 260, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 260, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 260 or explicit connections of a user to a node, object, entity, brand, or page on social-networking system 260. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. 2009/0070219, entitled “Targeting Advertisements in a Social Network” and filed 20 Aug. 2008 as U.S. patent application Ser. No. 12/195,321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. 2012/0159635, entitled “Comment Plug-In for Third-Party System” and filed 15 Dec. 2010 as U.S. patent application Ser. No. 12/969,368; U.S. Patent Application Publication No. 2012/0158753, entitled “Comment Ordering System” and filed 15 Dec. 2010 as U.S. patent application Ser. No. 12/969,408; U.S. Pat. No. 7,669,123, entitled “Dynamically Providing a News Feed About a User of a Social Network” and filed 11 Aug. 2006 as U.S. patent application Ser. No. 11/503,242; U.S. Pat. No. 8,402,094, entitled “Providing a Newsfeed Based on User Affinity for Entities and Monitored Actions in a Social Network Environment” and filed 11 Aug. 2006 as U.S. patent application Ser. No. 11/503,093; U.S. Patent Application Publication No. 2012/0072428, entitled “Action Clustering for News Feeds” and filed 16 Sep. 2010 as U.S. patent application Ser. No. 12/884,010; U.S. Patent Application Publication No. 2011/0004692, entitled “Gathering Information about Connections in a Social Networking Service” and filed 1 Jul. 2009 as U.S. patent application Ser. No. 12/496,606; U.S. Patent Application Publication No. 2008/0065701, entitled “Method and System for Tracking Changes to User Content in an Online Social Network” and filed 12 Sep. 2006 as U.S. patent application Ser. No. 11/531,154; U.S. Patent Application Publication No. 2008/0065604, entitled “Feeding Updates to Landing Pages of Users of an Online Social Network from External Sources” and filed 17 Jan. 2007 as U.S. patent application Ser. No. 11/624,088; U.S. Pat. No. 8,244,848, entitled “Integrated Social-Network Environment” and filed 19 Apr. 2010 as U.S. patent application Ser. No. 12/763,171; U.S. Patent Application Publication No. 2011/0083101, entitled “Sharing of Location-Based Content Item in Social-Networking Service” and filed 6 Oct. 2009 as U.S. patent application Ser. No. 12/574,614; U.S. Pat. No. 8,150,844, entitled “Location Ranking Using Social-Graph Information” and filed 18 Aug. 2010 as U.S. patent application Ser. No. 12/858,718; U.S. patent application Ser. No. 13/051,286, entitled “Sending Notifications to Users Based on Users' Notification Tolerance Levels” and filed 18 Mar. 2011; U.S. patent application Ser. No. 13/096,184, entitled “Managing Notifications Pushed to User Devices” and filed 28 Apr. 2011; U.S. patent application Ser. No. 13/276,248, entitled “Platform-Specific Notification Delivery Channel” and filed 18 Oct. 2011; or U.S. Patent Application Publication No. 2012/0197709, entitled “Mobile Advertisement with Social Component for Geo-Social Networking System” and filed 1 Feb. 2011 as U.S. patent application Ser. No. 13/019,061. Although this disclosure describes or illustrates particular advertisements being delivered in particular ways and in connection with particular content, this disclosure contemplates any suitable advertisements delivered in any suitable ways and in connection with any suitable content.

In particular embodiments, social-networking system 260 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 270 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 260 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 260 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 260 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 260 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 260 may calculate a coefficient based on a user's actions. Social-networking system 260 may monitor such actions on the online social network, on a third-party system 270, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 260 may calculate a coefficient based on the user's actions with particular types of content. The content may be associated with the online social network, a third-party system 270, or another suitable system. The content may include users, profile pages, posts, news stories, headlines, instant messages, chat room conversations, emails, advertisements, pictures, video, music, other suitable objects, or any combination thereof. Social-networking system 260 may analyze a user's actions to determine whether one or more of the actions indicate an affinity for subject matter, content, other users, and so forth. As an example and not by way of limitation, if a user frequently posts content related to “coffee” or variants thereof, social-networking system 260 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 260 may calculate a coefficient based on the type of relationship between particular objects. Referencing the social graph 300, social-networking system 260 may analyze the number and/or type of edges 306 connecting particular user nodes 302 and concept nodes 304 when calculating a coefficient. As an example and not by way of limitation, user nodes 302 that are connected by a spouse-type edge (representing that the two users are married) may be assigned a higher coefficient than a user nodes 302 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 260 may determine that the user has a higher coefficient with respect to the first photo than the second photo because having a tagged-in-type relationship with content may be assigned a higher weight and/or rating than having a like-type relationship with content. In particular embodiments, social-networking system 260 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 260 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 300. As an example and not by way of limitation, social-graph entities that are closer in the social graph 300 (i.e., fewer degrees of separation) may have a higher coefficient than entities that are further apart in the social graph 300.

In particular embodiments, social-networking system 260 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 230 of the user). A first user may be more interested in other users or concepts that are closer to the first user. As an example and not by way of limitation, if a user is one mile from an airport and two miles from a gas station, social-networking system 260 may determine that the user has a higher coefficient for the airport than the gas station based on the proximity of the airport to the user.

In particular embodiments, social-networking system 260 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 260 may provide information that is relevant to user's interests and current circumstances, increasing the likelihood that they will find such information of interest. In particular embodiments, social-networking system 260 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 260 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 260 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 270 (e.g., via an API or other communication channel), or from another suitable system. In response to the request, social-networking system 260 may calculate the coefficient (or access the coefficient information if it has previously been calculated and stored). In particular embodiments, social-networking system 260 may measure an affinity with respect to a particular process. Different processes (both internal and external to the online social network) may request a coefficient for a particular object or set of objects. Social-networking system 260 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 304 corresponding to a particular photo may have a privacy setting specifying that the photo may only be accessed by users tagged in the photo and their friends. In particular embodiments, privacy settings may allow users to opt in or opt out of having their actions logged by social-networking system 260 or shared with other systems (e.g., third-party system 270). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 270, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 262 may be authorization/privacy servers for enforcing privacy settings. In response to a request from a user (or other entity) for a particular object stored in a data store 264, social-networking system 260 may send a request to the data store 264 for the object. The request may identify the user associated with the request and may only be sent to the user (or a client system 230 of the user) if the authorization server determines that the user is authorized to access the object based on the privacy settings associated with the object. If the requesting user is not authorized to access the object, the authorization server may prevent the requested object from being retrieved from the data store 264, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

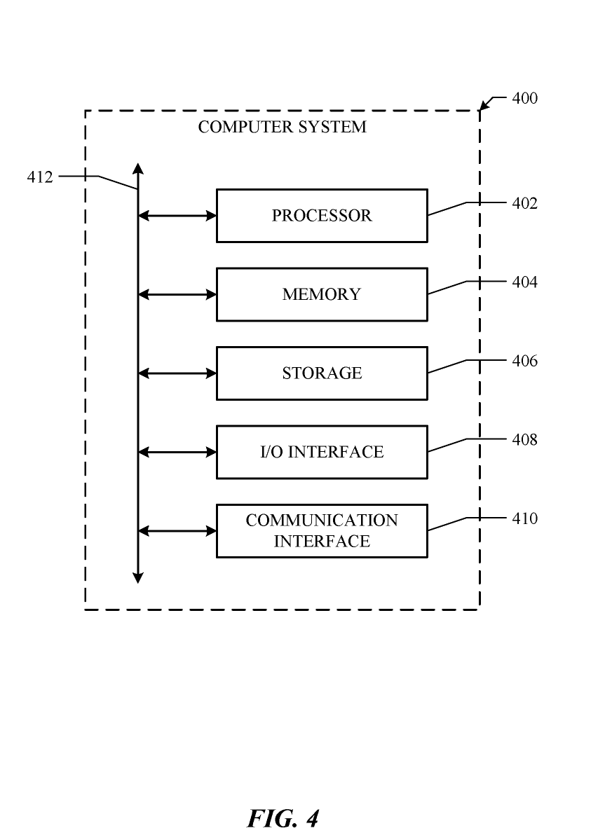

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing device, receiving instructions from a user of a social-networking system to create a messaging campaign, the instructions including a blocking instruction;
by the computing device, identifying a target user of the social-networking system to whom to present a message associated with the messaging campaign;
by the computing device, presenting the message to the target user;
by the computing device, receiving from the target user an input associated with the presented message, the input being configured to cause the message to be presented to one or more other users connected to the target user within a threshold degree of separation in a social graph;
by the computing device, in response to the input from the target user, determining that the message is associated with the blocking instruction; and
by the computing device, preventing the message from being presented to the one or more other users.

2. The method of claim 1, wherein the input from the target user is a comment or indicates an affinity for the message.

3. The method of claim 1, wherein the preventing of the message to be presented comprises preventing a notification to be sent to the one or more other users regarding the target user's input associated with the presented message.

4. The method of claim 1, wherein the preventing of the message to be presented comprises preventing the message to be included in a newsfeed of one of the other users, the newsfeed being generated by the social-networking system.

5. The method of claim 1, further comprising:
by the computing device, generating a command user interface associated with the message;
by the computing device, disabling a sharing option of the command user interface for sharing the message with other users of the social-networking system; and
by the computing device, presenting the command user interface with the disabled sharing option to the target user.

6. The method of claim 1, further comprising:
by the computing device, receiving from a second user at least a portion of a Uniform Resource Identifier (URI) associated with the message presented to the target user;
by the computing device, determining that the message is associated with the blocking instruction;
by the computing device, determining whether the second user is one of a plurality of target users intended to see messages associated with the messaging campaign; and
by the computing device, denying access to the message based on a determination that the second user is not one of the plurality of target users.

7. The method of claim 1, wherein a user-specific Uniform Resource Identifier (URI) is associated with the message presented to the target user, wherein the user-specific URI comprises information that uniquely identifies the target user.

8. The method of claim 7, further comprising:
by the computing device, receiving from a second user at least a portion of the user-specific URI;
by the computing device, determining whether the second user matches the information in the user-specific URI that uniquely identities the target user; and
by the computing device, denying access to the message based on a determination that the second user does not match the information that uniquely identities the target user.

9. One or more computer-readable non-transitory storage media comprising software that is operable when executed to:
receive instructions from a user of a social-networking system to create a messaging campaign, the instructions including a blocking instruction;
identify a target user of the social-networking system to whom to present a message associated with the messaging campaign;
present the message to the target user;
receive from the target user an input associated with the presented message, the input being configured to cause the message to be presented to one or more other users connected to the target user within a threshold degree of separation in a social graph;
in response to the input from the target user, determine that the message is associated with the blocking instruction; and
prevent the message from being presented to the one or more other users.

10. The media of claim 9, wherein the preventing of the message to be presented comprises preventing the message to be included in a newsfeed of one of the other users, the newsfeed being generated by the social-networking system.

11. The media of claim 9, wherein the software is further operable when executed to:
generate a command user interface associated with the message;
disable a sharing option of the command user interface for sharing the message with other users of the social-networking system; and
present the command user interface with the disabled sharing option to the target user.

12. The media of claim 9, wherein the software is further operable when executed to:
receive from a second user at least a portion of a Uniform Resource Identifier (URI) associated with the message presented to the target user;
determine that the message is associated with the blocking instruction;
determine whether the second user is one of a plurality of target users intended to see messages associated with the messaging campaign; and
deny access to the message based on a determination that the second user is not one of the plurality of target users.

13. The media of claim 9, wherein a user-specific Uniform Resource Identifier (URI) is associated with the message presented to the target user, wherein the user-specific URI comprises information that uniquely identifies the target user.

14. The media of claim 13, wherein the software is further operable when executed to:
receive from a second user at least a portion of the user-specific URI;
determine whether the second user matches the information in the user-specific URI that uniquely identities the target user; and
deny access to the message based on a determination that the second user does not match the information that uniquely identities the target user.

15. A system comprising:
one or more processors; and
one or more computer-readable non-transitory storage media coupled to one or more of the processors and comprising instructions operable when executed by one or more of the processors to cause the system to:
receive instructions from a user of a social-networking system to create a messaging campaign, the instructions including a blocking instruction;
identify a target user of the social-networking system to whom to present a message associated with the messaging campaign;
present the message to the target user;
receive from the target user an input associated with the presented message, the input being configured to cause the message to be presented to one or more other users connected to the target user within a threshold degree of separation in a social graph;
in response to the input from the target user, determine that the message is associated with the blocking instruction; and
prevent the message from being presented to the one or more other users.

16. The system of claim 15, wherein the preventing of the message to be presented comprises preventing the message to be included in a newsfeed of one of the other users, the newsfeed being generated by the social-networking system.

17. The system of claim 15, wherein the instructions are further operable when executed by one or more of the processors to cause the system to:
generate a command user interface associated with the message;
disable a sharing option of the command user interface for sharing the message with other users of the social-networking system; and
present the command user interface with the disabled sharing option to the target user.

18. The system of claim 15, wherein the instructions are further operable when executed by one or more of the processors to cause the system to:
receive from a second user at least a portion of a Uniform Resource Identifier (URI) associated with the message presented to the target user;
determine that the message is associated with the blocking instruction;
determine whether the second user is one of a plurality of target users intended to see messages associated with the messaging campaign; and
deny access to the message based on a determination that the second user is not one of the plurality of target users.

19. The system of claim 15, wherein a user-specific Uniform Resource Identifier (URI) is associated with the message presented to the target user, wherein the user-specific URI comprises information that uniquely identifies the target user.

20. The system of claim 19, wherein the instructions are further operable when executed by one or more of the processors to cause the system to:
receive from a second user at least a portion of the user-specific URI;
determine whether the second user matches the information in the user-specific URI that uniquely identities the target user; and
deny access to the message based on a determination that the second user does not match the information that uniquely identities the target user.
